(19) United States
(12) Patent Application Publication
(10) Pub. No.: US 2013/0178163 A1
(43) Pub. Date: Jul. 11, 2013

(54) Systems for Facilitating Wireless Communication and Related Methods

(71) Applicant: HTC Corporation, Taoyuan City (TW)

(72) Inventor: Huaiyuan Wang, Cary, NC (US)

(73) Assignee: HTC CORPORATION, Taoyuan City (TW)

(21) Appl. No.: 13/737,007

(22) Filed: Jan. 9, 2013

Related U.S. Application Data
(63) Continuation-in-part of application No. 13/372,701, filed on Feb. 14, 2012.
(60) Provisional application No. 61/584,926, filed on Jan. 10, 2012.
(60) Provisional application No. 61/592,556, filed on Jan. 30, 2012.

(51) Int. Cl. H04W 4/00

(52) U.S. Cl. CPC H04W 4/008
USPC 455/41.2

(57) ABSTRACT

Systems for facilitating wireless communication and related methods are provided. In this regard, a representative system includes: an electronic device operative to communicate using Bluetooth Low Energy (BLE) and at least a second radio format different from BLE, the device having a radio monitoring system operative to: monitor BLE advertising channels; receive information corresponding to a multi-radio-capable device via BLE Advertisement packets communicated on at least one of the BLE advertising channels; and establish communication with the multi-radio-capable device using the information provided by the BLE Advertisement packets.

### CROSS REFERENCE TO RELATED APPLICATION

This application is a continuation-in-part application that claims priority to co-pending U.S. Patent Application entitled, “Systems for Facilitating Wireless Communication and Related Methods”, having Ser. No. 13/372,701, filed Feb. 14, 2012, which claims priority to U.S. Provisional Patent Application entitled, “Bluetooth Low Energy Assisted Low Power Wi-Fi Detection”, having Ser. No. 61/584,926, filed Jan. 10, 2012, and U.S. Provisional Patent Application entitled, “Systems for Facilitating Wireless Communication and Related Methods”, having Ser. No. 61/592,556, filed Jan. 30, 2012, with each of the aforementioned applications being entirely incorporated herein by reference.

### TECHNICAL FIELD

The present disclosure generally relates to Wi-Fi communication.

### BACKGROUND

An electronic device, such as mobile phone or tablet computer, may be configured to scan for a Wi-Fi-capable device, such as a Wi-Fi access point (AP) or a peer device (e.g., Wi-Fi speakers, Wi-Fi dongles, Wi-Fi printers, etc.) with Wi-Fi capability. Scanning for a Wi-Fi-capable device may be performed by the electronic device in a passive manner. For instance, in the U.S., there are currently 12 and 23 operating channels in the 2.4 and 5 GHz bands, respectively. For each scan cycle, the device typically scans for all 35 channels and monitors for beacon transmission on each of the channels for up to the duration of the beacon interval, which is typically 100 ms. Assuming Wi-Fi passive scanning is performed every 5 minutes, this translates to a 3500 ms passive scanning time every 5 minutes, which corresponds to a duty cycle of 1.167%. Assuming 70 mA power consumption for the Wi-Fi receiver of the device, this corresponds to power consumption of over 0.8 mAh for each scan cycle.

### SUMMARY

Systems for facilitating wireless communication and related methods are provided. Briefly described, one embodiment, among others, is a system comprising: an electronic device operative to communicate using Bluetooth Low Energy (BLE) and at least a second radio format different from BLE, the device having a radio monitoring system operative to: monitor BLE advertising channels; receive information corresponding to a multi-radio-capable device via BLE Advertisement packets communicated on at least one of the BLE advertising channels; and establish communication with the multi-radio-capable device using the information provided by the BLE Advertisement packets.

Another embodiment is a method for method for facilitating wireless communication comprising: monitoring BLE advertising channels with an electronic device; receiving, at the electronic device, information corresponding to a multi-radio-capable device via BLE Advertisement packets associated with at least one of the BLE advertising channels; and establishing communication between the electronic device and the multi-radio-capable device via appropriate communication protocol using the information provided by the BLE Advertisement packets.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a system for facilitating wireless communication.

FIG. 2 is a flowchart depicting an example embodiment of a method for facilitating wireless communication.

FIG. 3 is a flowchart depicting another example embodiment of a method for facilitating wireless communication.

FIG. 4 is a communication flow diagram depicting functionality that may be performed by the embodiment of FIG. 1.

FIG. 5 is a schematic diagram of an example embodiment of an electronic device.

FIG. 6 is a flowchart depicting functionality that may be performed by an example embodiment of an electronic device, such as that depicted in FIG. 5.

FIG. 7 is a schematic diagram of an example embodiment of a Wi-Fi access point.

FIG. 8 is a flowchart depicting functionality that may be performed by an example embodiment of a Wi-Fi access point, such as that depicted in FIG. 7.

FIG. 9 is a schematic diagram of an example embodiment of a system for facilitating wireless communication.

FIG. 10 is a flowchart depicting an example embodiment of a method for facilitating wireless communication.

FIG. 11 is a flowchart depicting another example embodiment of a method for facilitating wireless communication.

FIG. 12 is a schematic diagram of an example embodiment of an electronic device.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, systems for facilitating wireless communication and related methods are provided, some embodiments of which involve the use of Bluetooth transmitters associated with Wi-Fi-capable devices (i.e., devices capable of Wi-Fi communication). By way of example, in some embodiments, a Bluetooth transmitter may be collocated (e.g., provided within a common housing) with a Wi-Fi capable device, such as a Wi-Fi access point (AP) or Wi-Fi peer device. In an example embodiment, a Bluetooth low energy (BLE) transmitter transmits Wi-Fi information associated with the Wi-Fi-capable device. An electronic device monitors for such information using a BLE receiver and, responsive to detecting the Wi-Fi information, may begin authentication and association or peer-to-peer connection procedures for facilitating communication with the Wi-Fi-capable device. Notably, use of the BLE receiver for monitoring for Wi-Fi information uses less energy than may be required for such scanning using standard Wi-Fi scanning procedures.

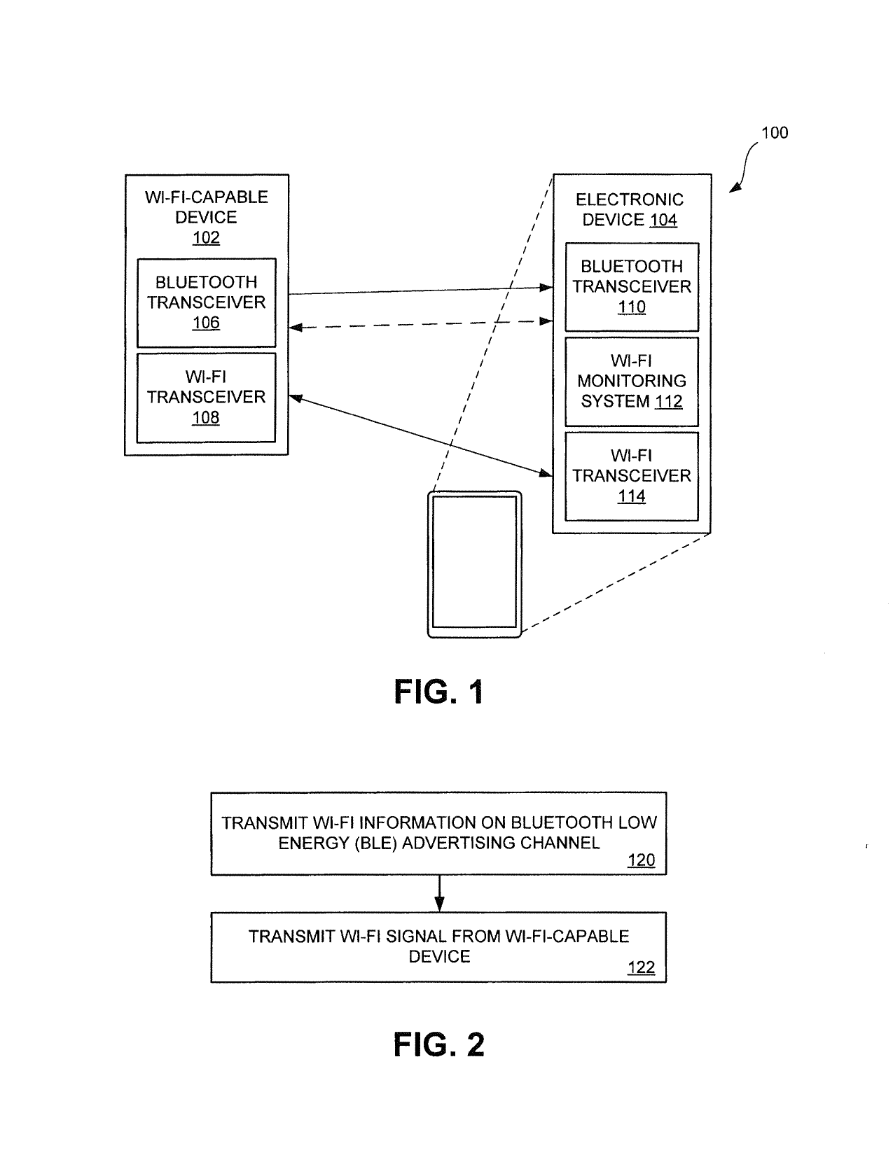

FIG. 1 is a schematic diagram of an example embodiment of a system for facilitating wireless communication. As shown in FIG. 1, system 100 includes a Wi-Fi capable device 102 and an electronic device 104, which may be configured as a smartphone or tablet computer, among others, for communicating with the Wi-Fi-capable device. The Wi-Fi-capable device incorporates a Bluetooth transceiver 106 and a Wi-Fi transceiver 108. It should be noted that the communication components in the embodiment of FIG. 1 (or any other disclosed embodiments) should be understood to alternatively refer to components that are only able to perform the functionality described. Thus, in this embodiment, reference to a transceiver, for example, may also be understood to refer to a transmitter when functionality only involving transmitting of signals is required. It should also be noted that the box surrounding the transceivers 106 and 108, although intended to indicate a physical structure such as a housing in FIG. 1, may merely indicate proximity of the enclosed components in other embodiments.

Electronic device 104 incorporates a Bluetooth transceiver 110 (e.g., a Bluetooth Low Energy (BLE) receiver), a Wi-Fi monitoring system 112 and a Wi-Fi transceiver 114. In operation, Bluetooth transceiver 110 scans (e.g., passively scans) for information in the form of Bluetooth advertisement packets (e.g., ADV_IND or ADV_NONCONN_IND packets) that contain Wi-Fi information, which is specific to the Wi-Fi-capable device. The transmission of a BLE advertisement packet is represented by the single arrowed line directed toward the electronic device. Notably, the Wi-Fi information carried by the BLE advertisement packets may include, but is not limited to, SSID, BSSID, operating band, channel number, and other predefined information elements for the Wi-Fi-capable device.

Responsive to detection of Wi-Fi information, Wi-Fi monitoring system 112 may optionally instruct the Bluetooth transceiver 110 to establish a data connection with Bluetooth transceiver 106 (represented by the double arrowed line) to further exchange information with the Wi-Fi-capable device 102. Upon receiving required information, Wi-Fi monitoring system 112 then enables Wi-Fi transceiver 114 to initiate authentication and association or peer-to-peer connection procedures with the Wi-Fi-capable device (represented by the double arrowed line) in order to establish communication between the electronic device and the Wi-Fi-capable device using appropriate Wi-Fi protocol.

While operating in this manner, energy typically consumed by performing Wi-Fi-based scans may be avoided, resulting in a corresponding reduction in energy usage of the electronic device. By way of example, if electronic device 104 sniffs for BLE packets for 11.25 ms in every 1.28 s, the duty cycle of such scanning is 0.88%. Based on a Bluetooth receiver power consumption of approximately 18 mA, only 0.158 mAh of power is consumed during each sniffing cycle (compared to 70 mA power consumption for a Wi-Fi receiver and power consumption of over 0.8 mAh for each scan cycle as described previously).

FIG. 2 is a flowchart depicting an example embodiment of a method for facilitating wireless communication, which may be performed by Wi-Fi-capable device 102 of FIG. 1, for example. As shown in FIG. 2, the method involves transmitting BLE Advertisements containing Wi-Fi information (and optionally predefined proprietary information elements) on a BLE advertising channel (block 120). In block 122, a Wi-Fi signal (which exhibits characteristics referenced in the Wi-Fi information, is transmitted from the Wi-Fi-capable device.

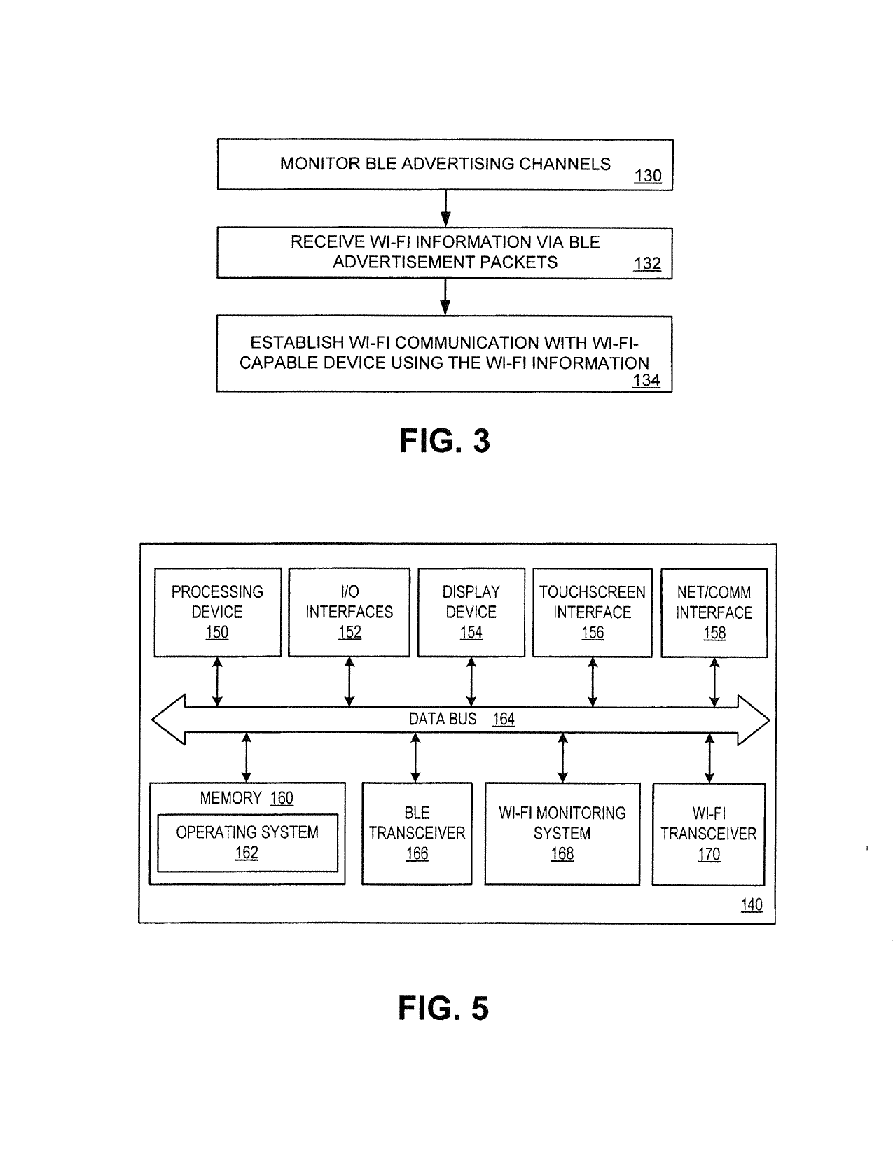

FIG. 3 is a flowchart depicting another example embodiment of a method for facilitating wireless communication, which may be performed by an electronic device. As shown in FIG. 3, the method involves monitoring BLE advertising channels for BLE Advertisement packets carrying Wi-Fi information (block 130). In block 132, Wi-Fi information is received. Then, as depicted in block 134, Wi-Fi communication is established with a Wi-Fi-capable device using the Wi-Fi information that was received via the BLE Advertisement packets. It should be noted that, in some embodiments, an optional function may be involved in which a BLE data connection is established to further exchange Wi-Fi-capable device information.

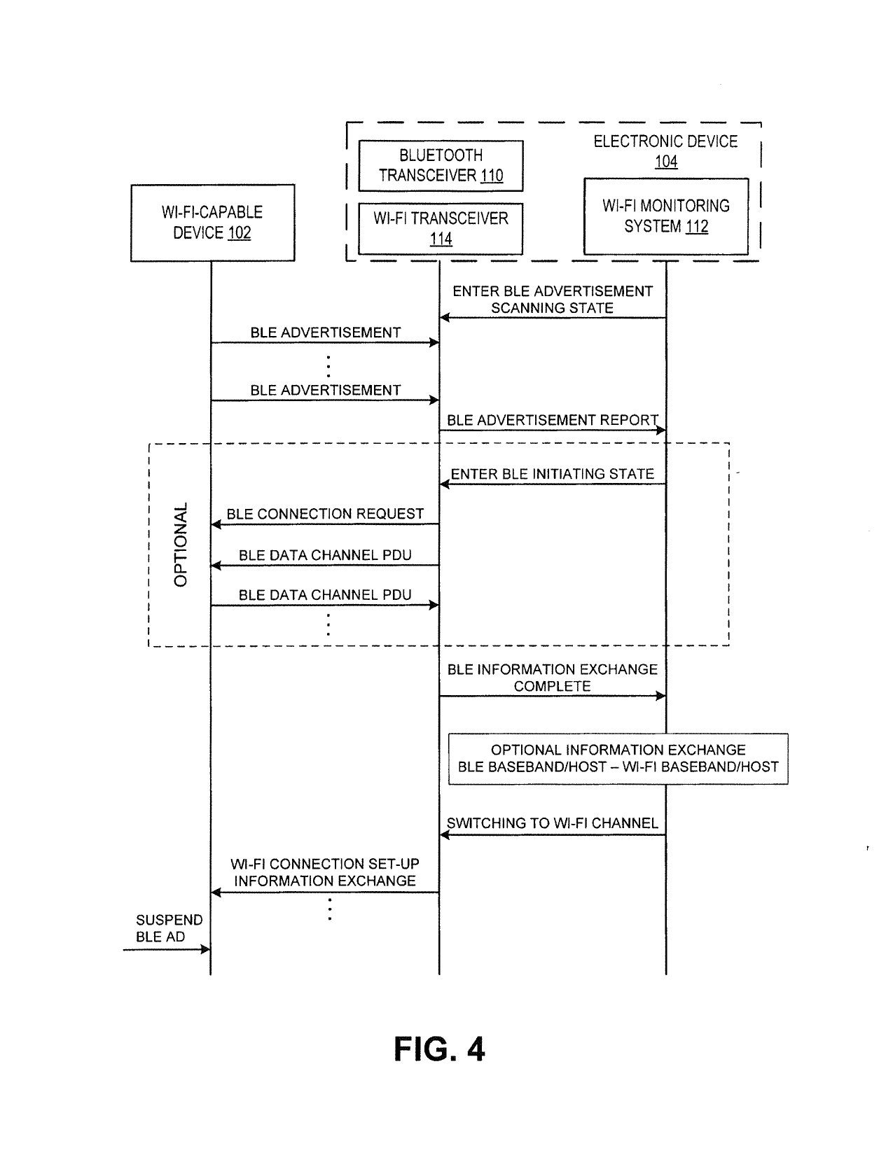

FIG. 4 is a communication flow diagram depicting functionality that may be performed by the embodiment of FIG. 1. As shown in FIG. 4, electronic device 104 enters a BLE Advertisement scanning state. Meanwhile, Wi-Fi-capable device 102 transmits BLE Advertisement packets, which are detected by Bluetooth transceiver 110. Responsive to the detection, a BLE Advertisement report is communicated to Wi-Fi monitoring system 112, after which an optional state is entered.

In the optional state, the Wi-Fi monitoring system enters a BLE Initiating State, in which the Bluetooth transceiver transmits a connection request to the Wi-Fi-capable device. Thereafter, an exchange of BLE data channel PDU is conducted. This optional state may end after the completion of the exchange of BLE information. It should also be noted that an optional information exchange may take place that involves an exchange of information corresponding to BLE baseband/host and Wi-Fi baseband/host.

After appropriate information exchanges are completed, the Wi-Fi monitoring system switches to Wi-Fi channel via the Wi-Fi transceiver 114 for communicating with the Wi-Fi-capable device. This is accomplished through a Wi-Fi connection set-up information exchange. Thereafter, the Wi-Fi-capable device may suspend BLE Advertisement, such as until the Wi-Fi connection is terminated, for example.

FIG. 5 is a schematic diagram of an example embodiment of an electronic device that may form a portion of a system for facilitating wireless communication. As shown in

FIG. 5, device 140 (which in this embodiment is configured as a smartphone) includes a processing device (processor) 150, input/output interfaces 152, a display device 154, a touchscreen interface 156, a network/communication interface 158, a memory 160, and an operating system 162, with each communicating across a local data bus 164. Additionally, the system incorporates a Bluetooth Low Energy transceiver 166, a Wi-Fi monitoring system 168 and a Wi-Fi transceiver 170.

The processing device 150 may include a custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 160 may include any one of a combination of volatile memory elements (e.g., random-access memory (RAM, such as DRAM, and SRAM, etc.)) and nonvolatile memory elements. The memory typically comprises native operating system 162, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device. Note that although depicted as being resident separate from memory 160, Wi-Fi monitoring system 168 may be stored in memory. The memory 160 may also be configured to exchange information between BLE transceiver 166, Wi-Fi monitoring system 168 and/or Wi-Fi transceiver 170.

Touchscreen interface 156 is configured to detect contact within the display area of the display 154 and provides such functionality as on-screen buttons, menus, keyboards, soft keys, etc. that allows users to navigate user interfaces by touch. Notably, navigating via the touchscreen interface may facilitate various functions associated with displayed content items such as searching and downloading.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 5, network/communication interface 158 comprises various components used to transmit and/or receive data over a networked environment. By way of example, such components may include a wireless communications interface. When such components are embodied as an application, the one or more components may be stored on a non-transitory computer-readable medium and executed by the processing device. Although capable of being depicted in association with the network/communication interface 158, BLE transceiver 166 and Wi-Fi transceiver 170 are depicted separately in this embodiment to facilitate description.

In particular, BLE transceiver 166 monitors for and receives information in the form of BLE Advertisement packets (e.g., ADV_IND or ADV_NONCONN_IND packets) that may contain Wi-Fi information. Such Wi-Fi information may include SSID, BSSID, operating band and channel number, as well as other proprietarily encoded information. Responsive to detection of Wi-Fi information, Wi-Fi monitoring system 168, which may optionally instruct Bluetooth transceiver 166 to establish a BLE data connection for further information exchange, enables Wi-Fi transceiver 170 to initiate authentication and association or peer-to-peer connection procedures with the Wi-Fi-capable device in order to establish communication between the electronic device and the Wi-Fi-capable device using appropriate Wi-Fi protocols.

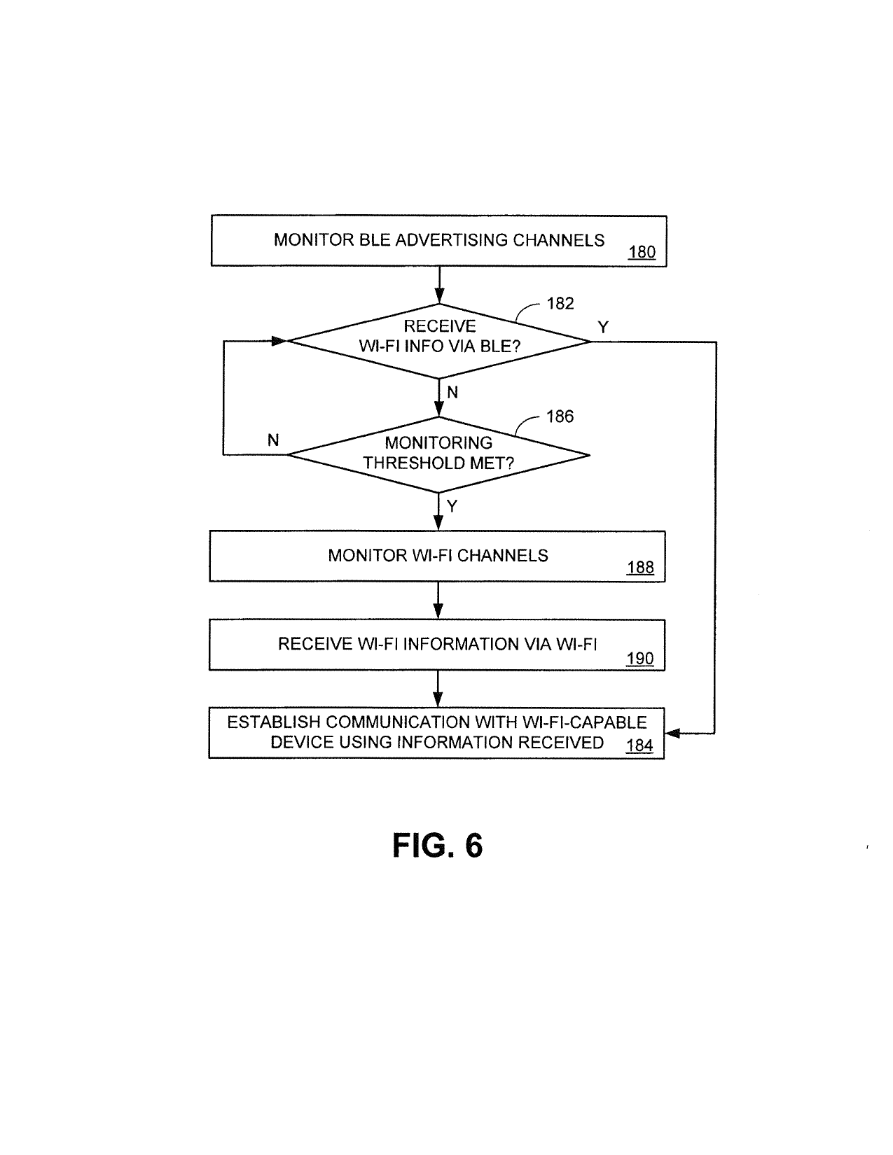

FIG. 6 is a flowchart depicting functionality that may be performed by an example embodiment of an electronic device, such as device 140 of FIG. 5. As shown in FIG. 6, the functionality (or method) may be construed as beginning at block 180, in which BLE advertising channels are monitored. In block 182, a determination is made as to whether BLE Advertisement packets containing Wi-Fi information has been received. If such information has been received, the process may proceed to block 184, in which communication may be established with the Wi-Fi-capable device using the received information. If, however, the BLE Advertisement packets containing Wi-Fi information have not been received, the process may proceed to block 186.

In block 186, a determination is made as to whether a BLE monitoring threshold has been met. By way of example, if sniffing for BLE packets has occurred for a predetermined period of time, number of cycles, etc., the threshold may be determined to have been met, responsive to which the process may proceed to block 188. In block 188, Wi-Fi channels are monitored by invoking appropriate Wi-Fi scanning procedures. Notably, this may allow access to a Wi-Fi-capable device that is only capable of communicating via Wi-Fi protocols. However, if it determined in block 186 that a threshold has not been met, the process may return to block 182 and proceed as previously described.

After monitoring of Wi-Fi channels in block 188, the process may proceed to block 190, in which Wi-Fi information is received via appropriate Wi-Fi scanning. Thereafter, such as depicted in block 184 (and regardless of whether the Wi-Fi information was obtained via Wi-Fi or BLE), communication may be established with a Wi-Fi-capable device.

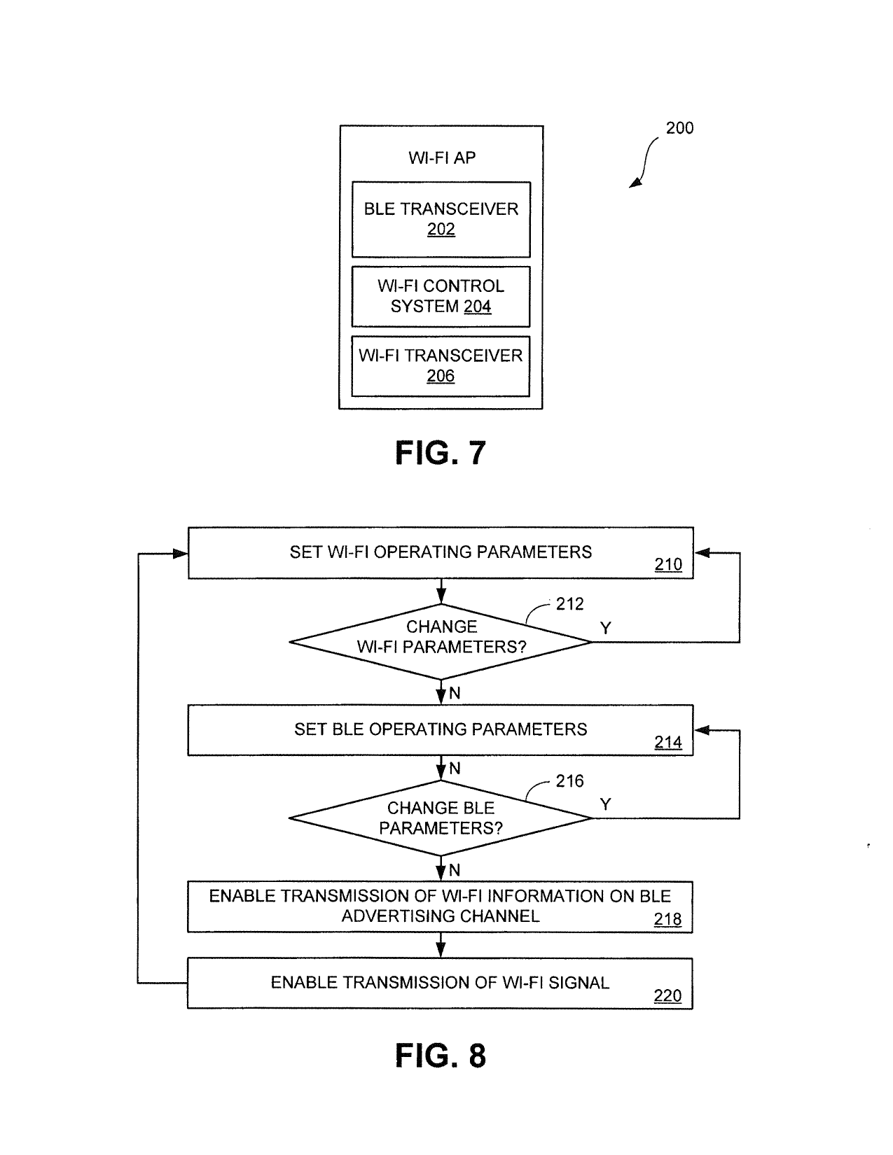

FIG. 7 is a schematic diagram of an example embodiment of a Wi-Fi-capable device. As shown in FIG. 7, Wi-Fi-capable device (or system) 200 incorporates a BLE transceiver 202, a Wi-Fi control system 204 and a Wi-Fi transceiver 206. In operation, the BLE transceiver 202 selectively transmits packets (e.g., ADV_IND or ADV_NONCONN_IND packets, for example) that contain Wi-Fi information. Wi-Fi control system 204 communicates with BLE transceiver 202 and Wi-Fi transceiver 206 to coordinate the transmission of the Wi-Fi information so that it corresponds to the operating parameters of the Wi-Fi transceiver. This coordination permits devices to establish Wi-Fi communication with the Wi-Fi-capable device.

In this regard, FIG. 8 is a flowchart depicting functionality that may be performed by an example embodiment of a Wi-Fi-capable device, such as by the Wi-Fi control system 204 depicted in FIG. 6. As shown in FIG. 8, the functionality (or method) may be construed as beginning at block 210, in which Wi-Fi operating parameters are set. For example, one or more of SSID, BSSID and channel number, among others, may be set. In block 212, a determination is made as to whether any changes are to be made to the Wi-Fi operating parameters. If changes are to be made, the process may return to block 210. If, however, changes are not to be made, the process may proceed to block 214, in which operating parameters of a BLE transceiver are set. The process may then proceed to block 216.

In block 216, a determination is made as to whether any changes are to be made to the BLE operating parameters. If changes are to be made, the process may return to block 214. If, however, changes are not to be made, the process may proceed to block 218, in which transmission of BLE Advertising packets containing Wi-Fi information on a BLE advertising channel is enabled. Optionally, proprietary information may be encoded into the BLE Advertisement packets prior to transmission. Then, as depicted in block 220, transmission of a Wi-Fi signal exhibiting the selected Wi-Fi operating parameters is enabled.

If embodied in software, it should be noted that each block depicted in the flowchart of FIG. 8 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

In some embodiments, a Bluetooth transmitter may be collocated (e.g., provided within a common housing) with a multi-radio-capable device, such as a device that uses a wireless transceiver operating on other than Wi-Fi protocols. This may be in addition to or to the exclusion of another collocated transceiver that uses Wi-Fi. In an example embodiment, a Bluetooth Low Energy (BLE) transmitter transmits information associated with the multi-radio-capable device. An electronic device monitors for such information using a BLE receiver and, responsive to detecting the information, may begin procedures for facilitating communication with the multi-radio-capable device.

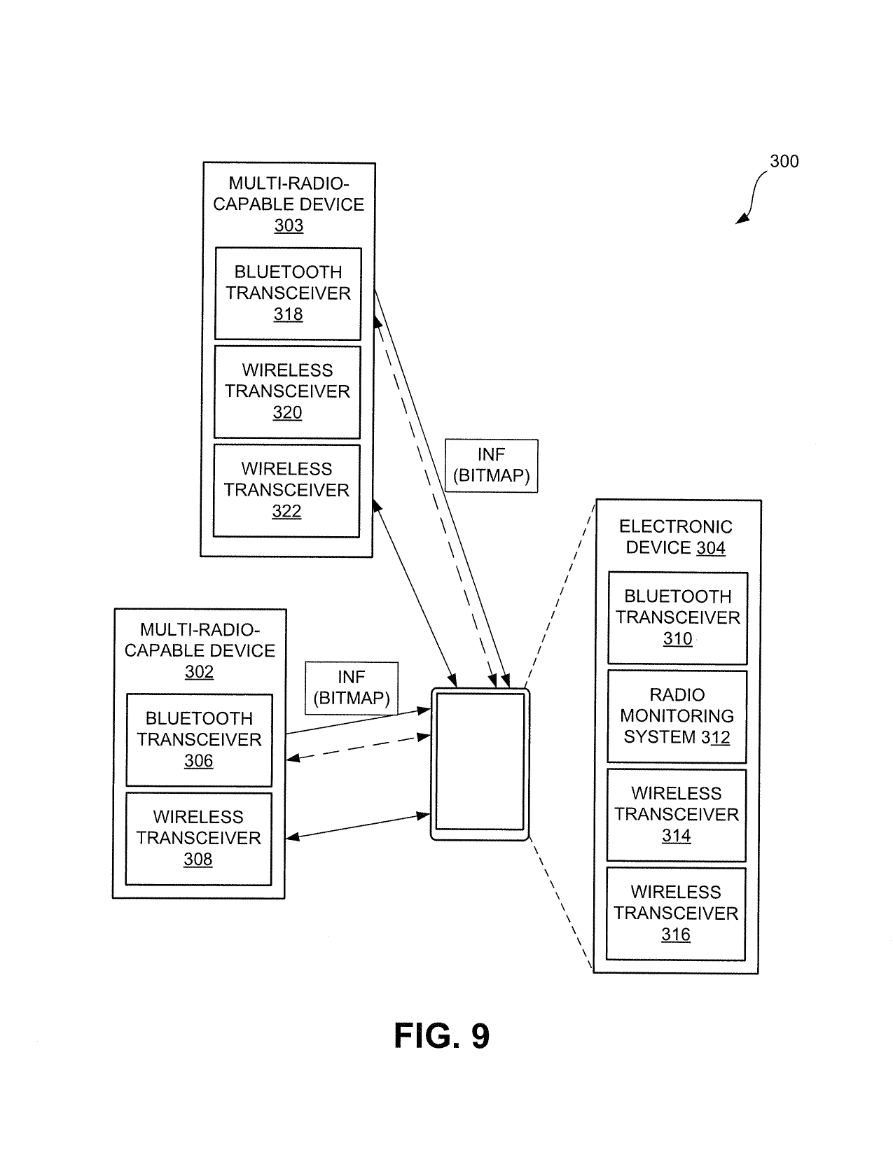

FIG. 9 is a schematic diagram of an example embodiment of a system for facilitating wireless communication. As shown in FIG. 9, system 300 includes multi-radio-capable devices 302 and 303, and an electronic device 304. Notably, the multi-radio-capable devices may be, for example, display devices, media set-top boxes, POS devices, audio systems, gaming consoles and home control systems. Additionally, electronic device 304 may be configured as a smartphone or tablet computer, among others, for communicating with the multi-radio-capable devices.

The multi-radio-capable device 302 incorporates a BLE transceiver 306 and a wireless transceiver 308. It should be noted that the communication components in the embodiment of FIG. 9 (or any other disclosed embodiments) should be understood to alternatively refer to components that are only able to perform the functionality described. Thus, in this embodiment, reference to a transceiver, for example, may also be understood to refer to a transmitter when functionality only involving transmitting of signals is required. It should also be noted that the box surrounding the transceivers 306 and 308, although intended to indicate a physical structure such as a housing in FIG. 9, may merely indicate proximity of the enclosed components in other embodiments.

The multi-radio-capable device 303 incorporates a BLE transceiver 318, and wireless transceivers 320 and 322. Notably the wireless transceivers 320, 322 each uses a different wireless radio interface and protocol (a protocol selected from among Wi-Fi, NFC, 60 GHz, ZigBee, and IR protocols, for example).

Electronic device 304 incorporates a BLE transceiver 310, a radio monitoring system 312 and wireless transceivers 314 and 316. In operation, Bluetooth Low Energy transceiver 310 scans (e.g., passively scans) for BLE advertisement packets (e.g., ADV_IND or ADV_NONCONN_IND packets) that contain information, which is specific to the multi-radio-capable devices 302 and 303. The transmission of a BLE advertisement packet is represented by the single arrowed line directed toward the electronic device. Notably, the information carried by the BLE advertisement packets in payloads may include, but is not limited to, SSID, BSSID, operating band, channel number, and other predefined information elements if the advertising multi-radio-capable device is Wi-Fi capable. In some embodiments, an advertising multi-radio-capable device may include in the payload of BLE advertisement packets additional bitmap elements, with each of the wireless radio capability of the multi-radio-capable device being represented by at least a bit (e.g., a bit combination) in the bitmap.

Responsive to detection of information, radio monitoring system 312 may optionally establish connection with one or more of the multi-radio-capable devices using the appropriate wireless radio interface and protocol.

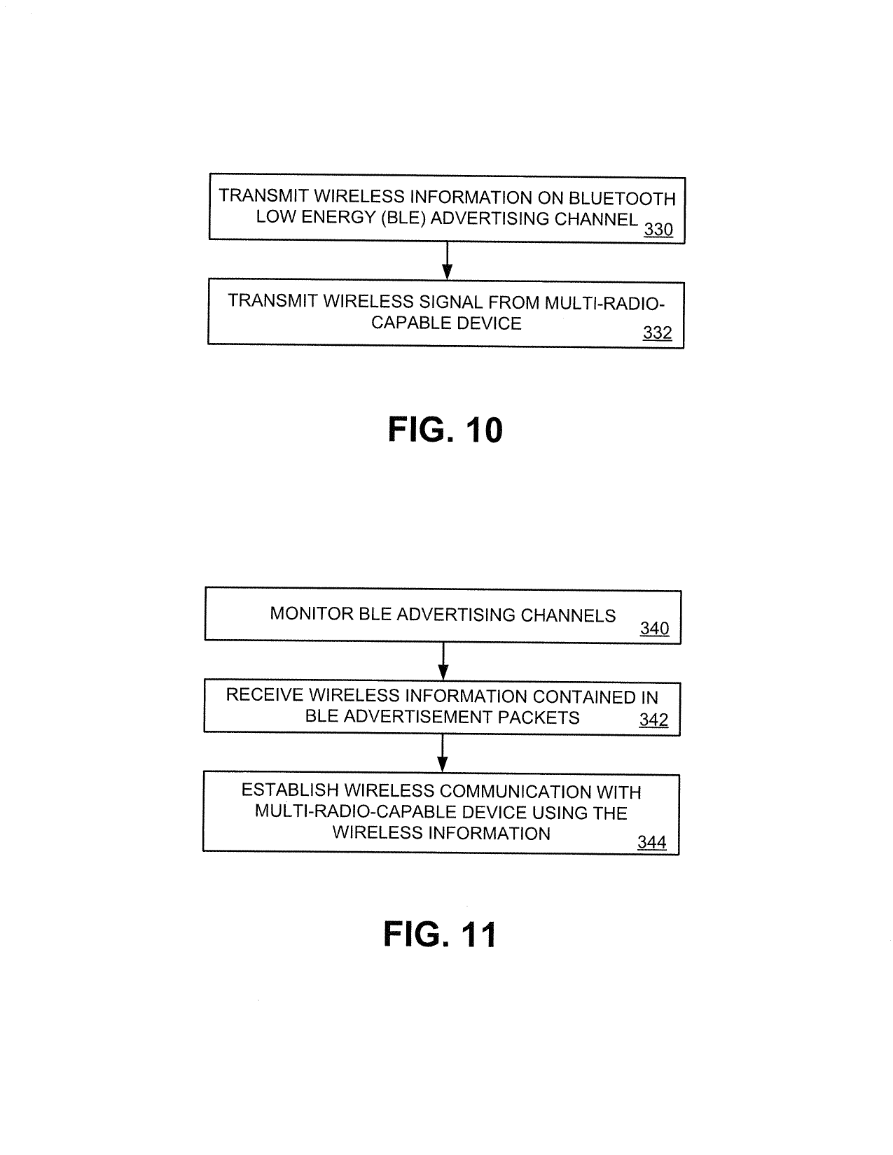

FIG. 10 is a flowchart depicting an example embodiment of a method for facilitating wireless communication, which may be performed by multi-radio-capable device 302 of FIG. 9, for example. As shown in FIG. 10, the method involves transmitting BLE Advertisements containing wireless information on a BLE advertising channel (block 330). In block 332, the multi-radio-capable device is readying itself for incoming connections by either transmitting wireless signal (which exhibits characteristics referenced in the wireless information) to other wireless devices or awaiting wireless signals transmitted by other wireless devices on respective radio interfaces.

FIG. 11 is a flowchart depicting another example embodiment of a method for facilitating wireless communication, which may be performed by an electronic device. As shown in FIG. 11, the method involves monitoring BLE advertising channels for BLE Advertisement packets carrying wireless radio capability information, such as may be provided in the form of a bitmap in some embodiments (block 340). In block 342, the wireless radio capability information is received. Then, as depicted in block 344, wireless communication is established with a multi-radio-capable device using the appropriate radio interface determined through the wireless radio capability information that was received via the BLE Advertisement packets. It should be noted that, in some embodiments, such as when a multi-radio-capable device includes the ability to communicate using more than one communications protocol, the electronic device may determine which of the radio interfaces and protocols to use for facilitating communication. In some embodiments, the determination of which protocol to use may be based on numerous factors such as the capabilities of other devices within communication proximity, among others.

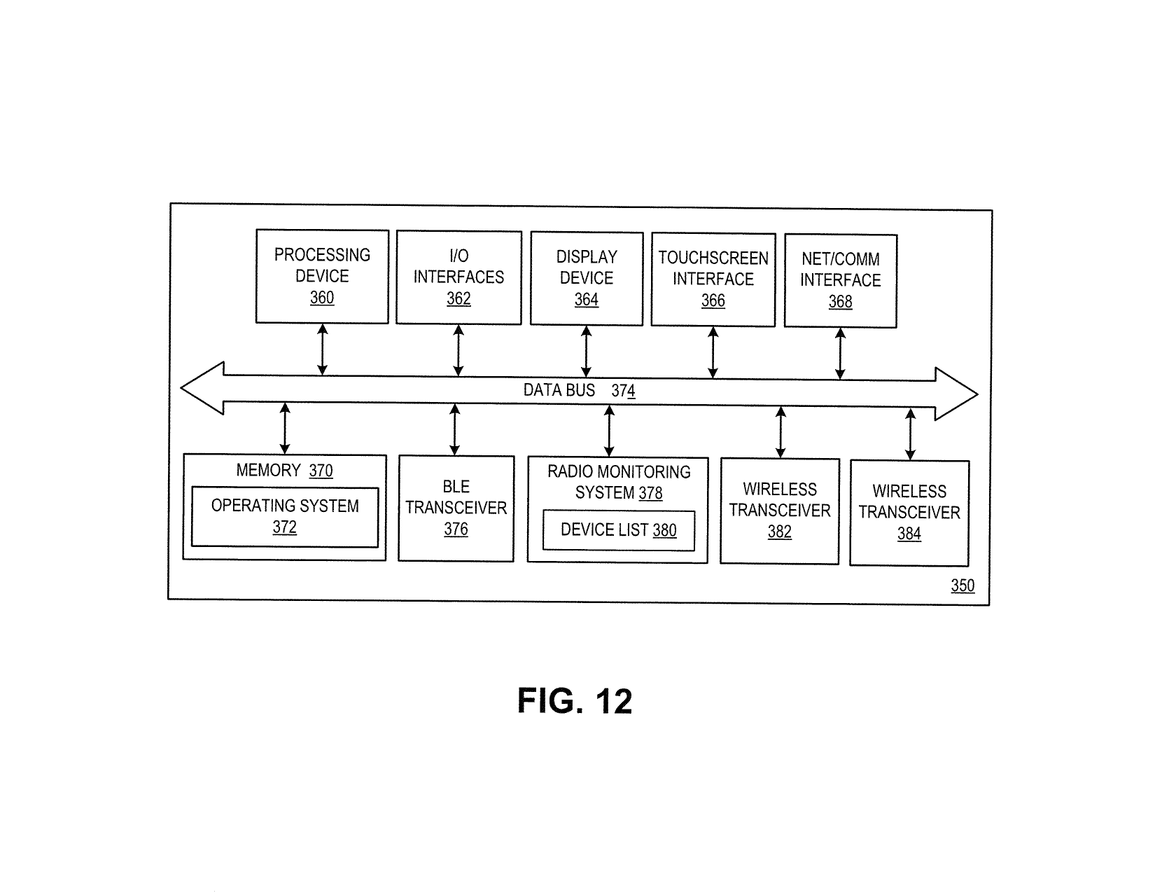

FIG. 12 is a schematic diagram of an example embodiment of an electronic device that may form a portion of a system for facilitating wireless communication. As shown in FIG. 12, device 350 (which in this embodiment is configured as a smartphone) includes a processing device (processor) 360, input/output interfaces 362, a display device 364, a touchscreen interface 366, a network/communication interface 368, a memory 370, and an operating system 372, with each communicating across a local data bus 374. Additionally, the system incorporates a Bluetooth Low Energy transceiver 376, a radio monitoring system 378 (which has access to a device list 380) and wireless transceivers 382 and 384. Notably, each of the transceivers 382, 384 uses a different communications protocol.

Operation of device 350 is similar in many respects to device 150 of FIG. 5, and as such, much of the operations will not be described again. In contrast to those operations, however, radio monitoring system 378 receives wireless information from devices, such as multi-radio-capable devices, via BLE transceiver 376. The information, which may be in the form of a bitmap, is used to build the device list 380. The device list contains information about the multi-radio-capable devices currently within the communications range of the device 350 and includes information pertaining to the radio interfaces present in those devices. Based on the information contained in the device list, the radio monitoring system determines which wireless technologies are appropriate for establishing communication with which of the multi-radio-capable devices and selectively establishes communication with the multi-radio-capable devices using selected wireless technologies.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A system for facilitating wireless communication comprising:
an electronic device operative to communicate using Bluetooth Low Energy (BLE) and at least a second radio format different from BLE, the device having a radio monitoring system operative to:
monitor BLE advertising channels;
receive information corresponding to a multi-radio-capable device via BLE Advertisement packets communicated on at least one of the BLE advertising channels; and
establish communication with the multi-radio-capable device using the information provided by the BLE Advertisement packets.

2. The system of claim 1, wherein the electronic device is operative to receive the information corresponding to a multi-radio-capable device via a bitmap contained in the BLE Advertisement packets, with at least a bit in the bitmap including information corresponding to an identification of various communication capability of the multi-radio-capable device.

3. The system of claim 1, wherein the electronic device is a smartphone.

4. The system of claim 1, wherein the electronic device is a tablet computer.

5. The system of claim 1, wherein the radio monitoring system is further operative to selectively establish communication with the multi-radio-capable device without using the information provided by the BLE Advertisement packets.

6. The system of claim 1, further comprising the multi-radio-capable device.

7. The system of claim 6, wherein the multi-radio-capable device has a BLE transceiver and a second transceiver operative to communicate using the second radio format.

8. The system of claim 7, further comprising a device housing, the BLE transceiver and the second transceiver of the multi-radio-capable device being carried by the housing.

9. The system of claim 1, wherein:
the electronic device has a BLE transceiver and a second transceiver operative to communicate using the second radio format; and
the radio monitoring system is further operative to facilitate monitoring of signals associated with a multi-radio-capable device such that monitoring for the signals is alternately performed by the BLE transceiver and the second transceiver.

10. The system of claim 1, wherein the radio monitoring system is further operative to selectively monitor Wi-Fi operating bands and channels for presence of a Wi-Fi-capable device.

11. A method for facilitating wireless communication comprising:
monitoring Bluetooth Low Energy (BLE) advertising channels with an electronic device;
receiving, at the electronic device, information corresponding to a multi-radio-capable device via BLE Advertisement packets associated with at least one of the BLE advertising channels; and
establishing communication between the electronic device and the multi-radio-capable device via appropriate communication protocol using the information provided by the BLE Advertisement packets.

12. The method of claim 11, wherein, in receiving the information corresponding to the multi-radio-capable device, the information received via a bitmap contained in the BLE Advertisement packets, with at least a bit in the bitmap including information corresponding to an identification of communication capability of the multi-radio-capable device.

13. The method of claim 12, wherein each wireless technology represented in the BLE Advertisement packets is associated with at least one corresponding bit of the bitmap.

14. The method of claim 11, further comprising:
receiving, at the electronic device, information corresponding to additional multi-radio-capable devices via BLE Advertisement packets;
determining which wireless technologies are appropriate for establishing communication with the multi-radio-capable devices; and
establishing communication with the multi-radio-capable devices using selected wireless technologies.

15. The method of claim 11, wherein receiving information corresponding to a multi-radio-capable device comprises receiving information corresponding to operating band and channel of the multi-radio-capable device.

16. The method of claim 11, further comprising monitoring the operating band and channel of the multi-radio-capable device responsive to receiving the information corresponding to the multi-radio-capable device.

17. The method of claim 11, further comprising selectively monitoring Wi-Fi operating bands and channels for presence of a Wi-Fi-capable device.

18. The method of claim 17, wherein selectively monitoring Wi-Fi comprises:
monitoring BLE advertising channels for information corresponding to a Wi-Fi-capable device unsuccessfully for a predetermined time period; and
monitoring for Wi-Fi operating bands and channels associated with a Wi-Fi-capable device responsive to the predetermined time period having elapsed.

19. The method of claim 17, wherein selectively monitoring Wi-Fi comprises alternately monitoring for BLE and Wi-Fi signals.
